(19) United States
(12) Patent Application Publication
(10) Pub. No.: US 2019/0016031 A1
(43) Pub. Date: Jan. 17, 2019

(54) Apparatus for injection moulding of plastic materials

(71) Applicant: INGLASS S.p.A., San Polo di Piave (Treviso) (IT)

(72) Inventor: Maurizio Bazzo, San Polo di Piave (Treviso) (IT)

(21) Appl. No.: 16/032,690

(22) Filed: Jul. 11, 2018

(30) Foreign Application Priority Data
Jul. 17, 2017 (IT) 102017000080662

(51) Int. Cl. B29C 45/27; B29C 45/28

(52) U.S. Cl. CPC B29C 45/2711; B29C 2045/2759; B29C 45/2806; B29C 45/278

(57) ABSTRACT

Apparatus for injection moulding of plastic material includes a mould having at least one gate towards a moulding cavity and at least one injector cooperating with the gate. The gate is formed by a gate insert screwed and arranged resting on a centring seat with conical surface of the mould.

### FIELD OF THE INVENTION

The present invention refers to apparatus for injection moulding of plastic materials comprising a mould having at least one gate towards a moulding cavity and at least one injector cooperating with the gate. The injector typically including a nozzle provided with a nozzle terminal defining a path for the flow of plastic material towards the gate.

### STATE OF THE ART

A conventional injection moulding apparatus is schematically represented—in partial section—in FIG. 1 of the attached drawings: it comprises a hot runner or distributor 1 for the fluid plastic material and one or more injectors 2, 3 for the introduction of pressurised plastic material into the cavity of a mould, whose plate or die is indicated with 4, through respective gates 5.

Each injector 2, 3 comprises a tubular nozzle 7 provided with a nozzle end, generally indicated with 8, which defines a fluid path for the injected plastic material. In the case of FIG. 1, the injectors 2, 3 are of the so-called “shutter” type: each one of them is provided with a valve pin 9 provided with a shutter terminal 10 that can be axially displaced, by means of an electrical or fluid actuator 11, between a receded position and an advanced position for opening and closing the nozzle terminal 8.

The nozzle terminal 8 may have different configurations, represented in detail by way of example in FIG. 2 relative to the injector 2 of FIG. 1, and in FIG. 3 relative to the injector 3 of FIG. 1. In both cases, the nozzle terminal 8 comprises an inner tubular element or tip 12 and an outer annular element or ring nut 13.

In the case of the nozzle terminal 8 of FIG. 2, the tip 12 extends axially with the distal end 12a thereof beyond the distal end 13a of the ring nut 13, projecting into the gate 5. Thus, the gate mark (represented in plan view under FIG. 2) which remains on the surface of the moulded article reveals very small dimensions, exclusively according to the diameter of the shutter terminal 10 of the valve pin 9, this being particularly advantageous when it comes to moulding aesthetic components, in particular transparent or semi-transparent, and even more so in the case of motor vehicle lamps which require very high quality standards.

This solution, so-called with “outer” ring nut i.e. one not directly projecting into the moulding cavity, requires an accurate operation of the mould die 4, at the height of the distal ends of the tip 12 and ring nut 13, due to the constant variation of the radial overall dimension thereof as well as in particular the area of the gate 5 which receives the shutter terminal 10 of the valve pin 9 in the advanced closing position thereof. This implies the extension of the moulding apparatus production, procurement and commissioning times. Furthermore, the machining difficulty often leads to concentricity errors between the shutter terminal 10 of the valve pin 9 and the gate 5 of the die 4, or the entire die insert if the gate 5 is not provided directly in the die 4 of the mould but rather in a hollow insert, indicated with 14, applied in a corresponding seat of the die 4. This entails a higher wear rate on the two components or even the breaking of the die or die insert, with serious economic damage for the mould.

The solution represented in FIG. 3, in which the nozzle terminal 8 is of the so-called “through” ring nut 13, i.e. whose distal end 13a axially extends beyond the distal end 12a of the tip 12 and it is directly projected into the moulding cavity, was proposed in an attempt to overcome such drawbacks. In this case, the gate 5 with which the shutter terminal 10 of the valve pin 9 cooperates is formed in the area of the distal end 13a of the ring nut 13, hence enabling considerable simplification in the operation of the die 4, hence reducing times and risk of error. However, as represented in plan view in the lower part of FIG. 3, to the gate mark corresponding to the shutter terminal 10 there is also added that of the distal end 13a of the ring nut 13, with dimensions that are much greater and actually unacceptable when it comes to moulding transparent aesthetic components and in particular motor vehicle lamp lenses.

The solution described in document US-2017/0100866 in the name of the Applicant, herein represented in FIG. 4, was proposed with the aim of overcoming these drawbacks.

This solution provides for an injector 7 wherein the tip 12 of the nozzle terminal 8 has a distal end 12a configured so as to be coupled with the gate 5, cooperate with the shutter terminal 10 of the valve pin 9 and have—in cross-section—an overall thickness 2A equal to or smaller than that of the cross-section B of the shutter terminal 10 of the valve pin 9. In this case, the gate 5 is formed in the die insert 14, inserted into the seat of a mould plate as mentioned.

The characteristic according to which the distal end 12a of the tip 12 is extended (so to say), i.e. it is such to be able to extend in the gate 5 of the mould to project into the moulding cavity, offers the advantage of considerably simplifying the operation of the die insert 4 of the mould.

On the other hand, the low wall thickness A of the distal end 12a of the tip 12 enables equally considerably reducing the dimensions of the gate mark visible on the moulded article, which will be slightly larger than the imprint of the shutter terminal of the valve pin and basically similar thereto.

However, the particularly thin and extended configuration of the distal end 12a of the tip 12 entails considerable dilatation in the axial direction, upon the variation of the moulding conditions.

This negatively affects the aesthetic quality of the moulded component, in that the distal end 12a will tend to retract or extend axially.

In the first case there will be a non-perfect closing coupling between the distal end 12a of the tip 12 and the shutter terminal 10 of the valve pin 9, with ensuing formation of burrs in proximity of the gate 5.

In the second case instead, the distal end 12a of the tip will extend beyond the gate 5 into the moulding cavity, thus leaving a much more marked, evident and aesthetically unacceptable gate mark (some sort of coining) on the moulded piece.

FIGS. 5 and 6 schematically show the state of the art regarding injectors of the “free-flow” type. Contrary to what has been described up to now, the use of a valve pin that can be displaced axially by means of an actuator is not provided for. The nozzle terminal 8a provides for shutting off the flow of the injected plastic material at the gate 5 by simply acting on the temperatures, in particular by cooling the plastic material at the end of the injection to solidify and stop the flow.

Similarly to the cases of FIGS. 1-4, the nozzle terminal 8a comprises an inner element or tip 12 and an outer annular element or ring nut 13. In particular in the cases of FIGS. 5 and 6, the tip 12 is of the “torpedo” type, i.e. characterised by a conical-shaped distal section which ends with the vertex 12a thereof in proximity of the gate 5. The communication between the flow channel of the injector 7 and the gate 5 occurs through one or more inclined holes 30 obtained in the tip 12.

In FIG. 5, the ring nut 13 has a configuration similar to that of FIG. 2. As a matter of fact, it is “external”, i.e. it does not project into moulding cavity directly. As previously mentioned, this configuration requires accurate machining of the die insert 14 at the height of the distal ends of the tip 12 and ring nut 13, thus entailing an extension of the times required for producing, procuring and commissioning the moulding apparatus. Besides this, the die insert 14 is directly subjected to wear due to the flow of plastic material which flows during the numerous moulding cycles that are usually provided for. The wear is particularly accelerated when the plastic material is loaded with reinforcement material (e.g. glass fibre) with the aim of increasing the mechanical resistance of the moulded component. The wear of the die insert 14, in particular in the gate 5 area, is unacceptable in the long term due to the aesthetic quality of the moulded component. Thus, there arises the need to replace the entire die insert 14 (or the die 4 itself, if the insert 14 is not provided for) with ensuing increase of production times and costs as well as long shut down times.

The solution represented in FIG. 6, in which—similarly to the case of FIG. 3—the ring nut 13 is of the “through” type i.e. its distal end 13a axially extends beyond the distal end 12a of the tip 12 and it is directly projected into the moulding cavity, was proposed in an attempt to overcome such drawbacks. In this case, the gate 5 is formed in the area of the distal end 13a of the ring nut 13, hence enabling considerable simplification when it comes to machining the die insert 14. However, as schematised in plan view in the lower part of FIG. 6, the gate mark of the distal end 13a of the ring nut 13 has unacceptable dimensions from an aesthetic point of view if compared with the mark visible in FIG. 5.

US 2003/235638 discloses an injection moulding apparatus having a gate insert resting upon a centring seat of the mould having a conical surface. Similar arrangements are also disclosed in JP H07186203 and JP H05309695.

### SUMMARY OF THE INVENTION

The object of the present invention is to overcome the drawbacks of the aforementioned prior art solutions, so as to guarantee the desired aesthetic quality of the moulded details as well as lesser times and costs required for producing, procuring and commissioning the moulding apparatus.

This object is attained according to the invention by means of injection moulding apparatus of the type defined above, whose peculiar feature consists of that the gate insert has threading which is screwed with a corresponding threading of the mould.

The gate insert can be fitted within a hollow die insert applied in a mould plate and formed with the inner threading and the centring seat, or instead said inner threading and said centring seat for the gate insert can be directly formed in the mould plate.

The gate insert has conveniently a base formed centrally with an annular axial appendage coupled with the aforementioned centring seat and having a conical wall with thickness tapered towards the moulding cavity. Such axial appendage advantageously keeps the base of the gate insert spaced from the mould surface.

The invention considerably advantageously applies to injection moulding apparatus provided with multiple injectors controlled according to sequential or cascade cycles, or also in multi-cavity injection moulding characterised by a high number of moulding cycles with low times.

### BRIEF DESCRIPTION OF THE DRAWINGS

In the attached drawings:

FIG. 1 is a partially sectional schematic view of an apparatus for injection moulding of plastic materials according to the previously described prior art,

FIGS. 2 and 3 represent, in larger scale, two details of the prior art moulding apparatus according to FIG. 1,

FIG. 4 is a view analogous to FIGS. 2 and 3 showing a further prior art solution described previously,

FIGS. 5 and 6 represent two details of a moulding apparatus according to the other prior art variant described previously,

FIG. 7 is a view analogous to FIGS. 2-6 showing—by way of non-limiting example—an embodiment of the invention,

FIG. 8 shows an enlarged scale of a part of FIG. 7,

FIG. 9 shows a variant of FIG. 7,

FIG. 10 is a perspective view of the component referred to as gate insert according to the invention,

FIG. 11 is a bottom plan view of FIG. 10,

FIG. 12 is a cross-sectional view according to line X-X of FIG. 11, and

FIG. 13 shows—by way of non-limiting example—a further embodiment of the invention.

### DETAILED DESCRIPTION OF THE INVENTION

In order to overcome the drawbacks of the previously mentioned prior art solutions, the invention proposes a solution that is conceptually different and capable of guaranteeing the desired aesthetic quality of the moulded components as well as lesser times and costs required for producing, procuring and commissioning the injection moulding apparatus. Basically, the element of the invention consists of an insert, referred to as gate insert, positioned in proximity of the gate in a conventional gate insert, where present, or directly in a seat of the mould die or plate.

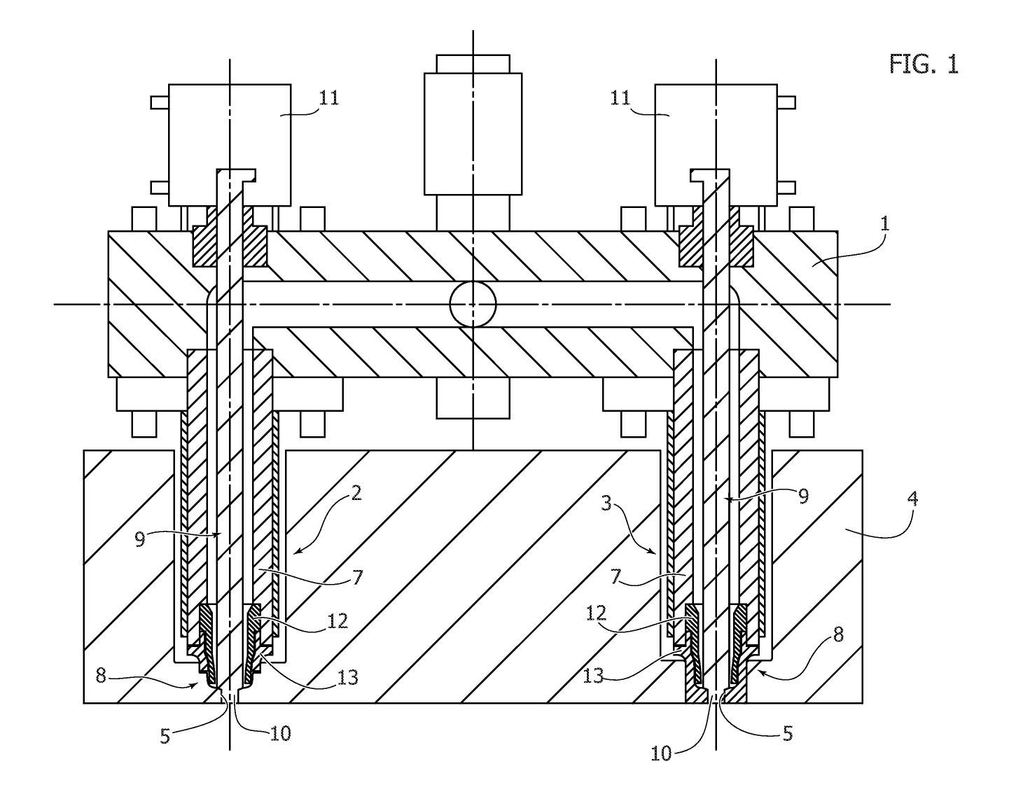

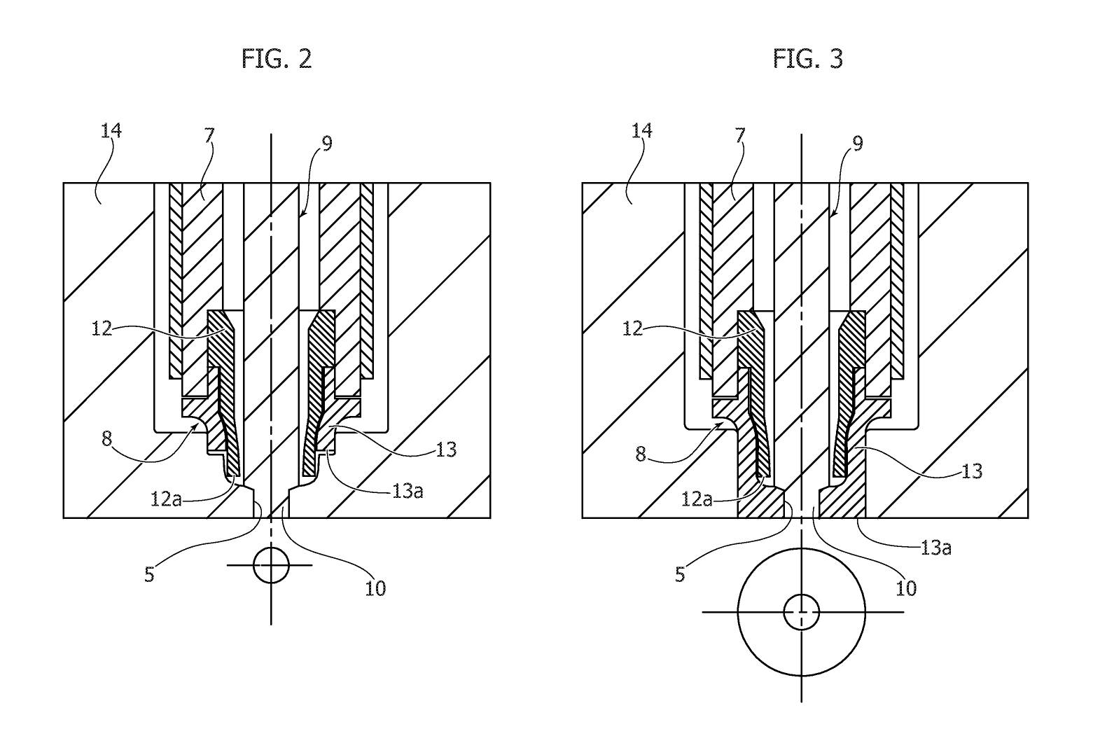

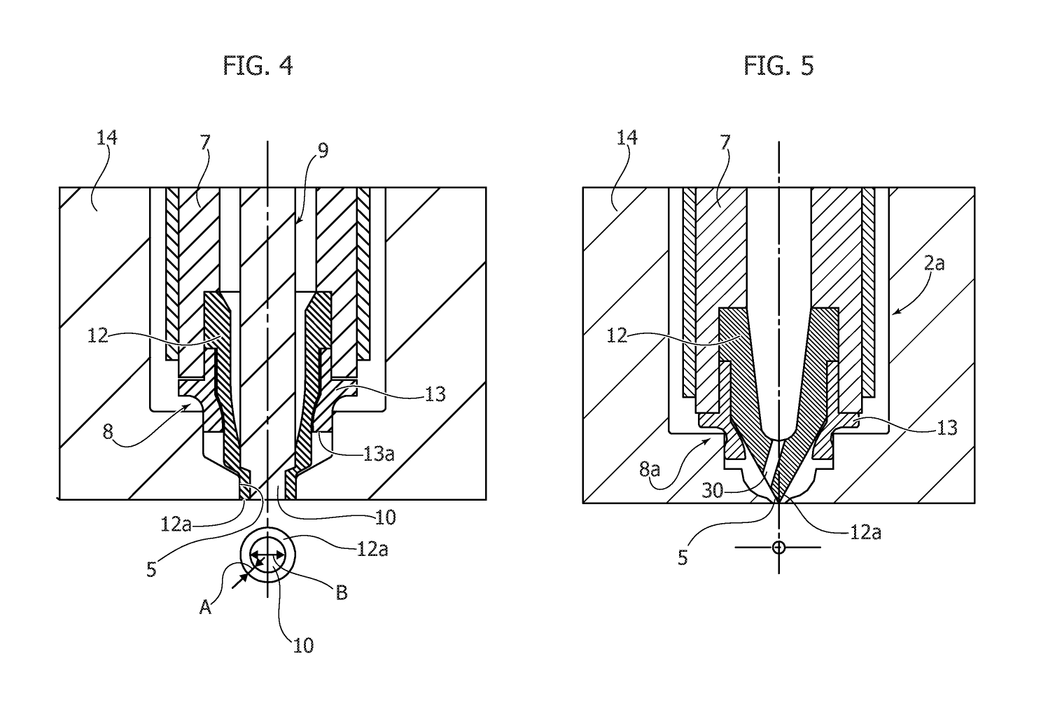

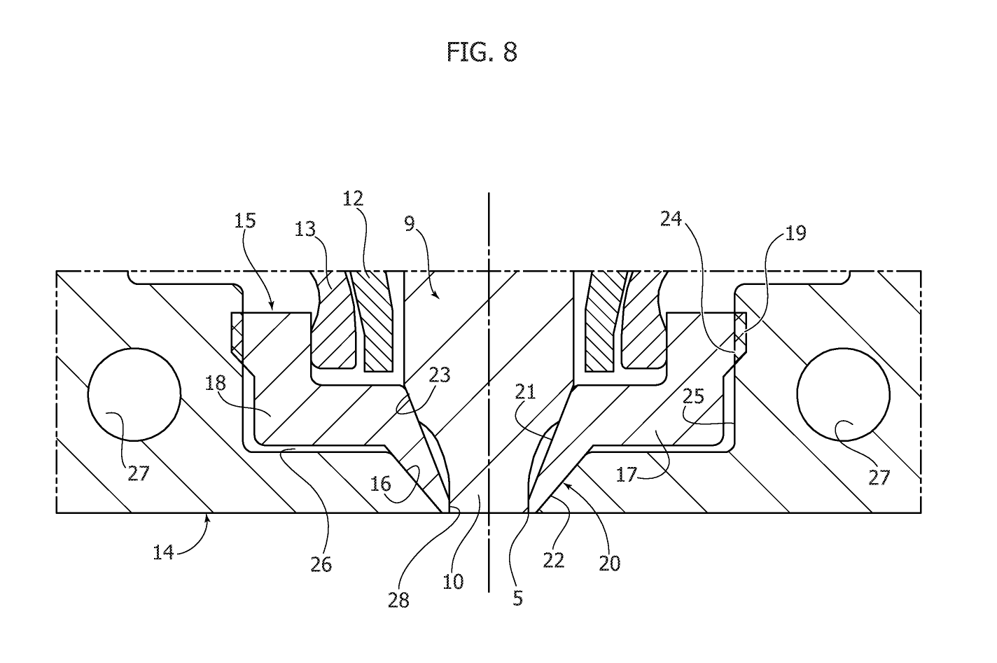

Initially referring to FIGS. 7 and 8, in which parts identical or similar to those described previously with reference to FIGS. 1-6 are indicated using the same reference numbers, this gate insert is indicated with 15 and it is screwed into the die insert 14 resting—at the lower part—on a seat 16—with conical surface—of such die insert 14 in proximity of the gate 5.

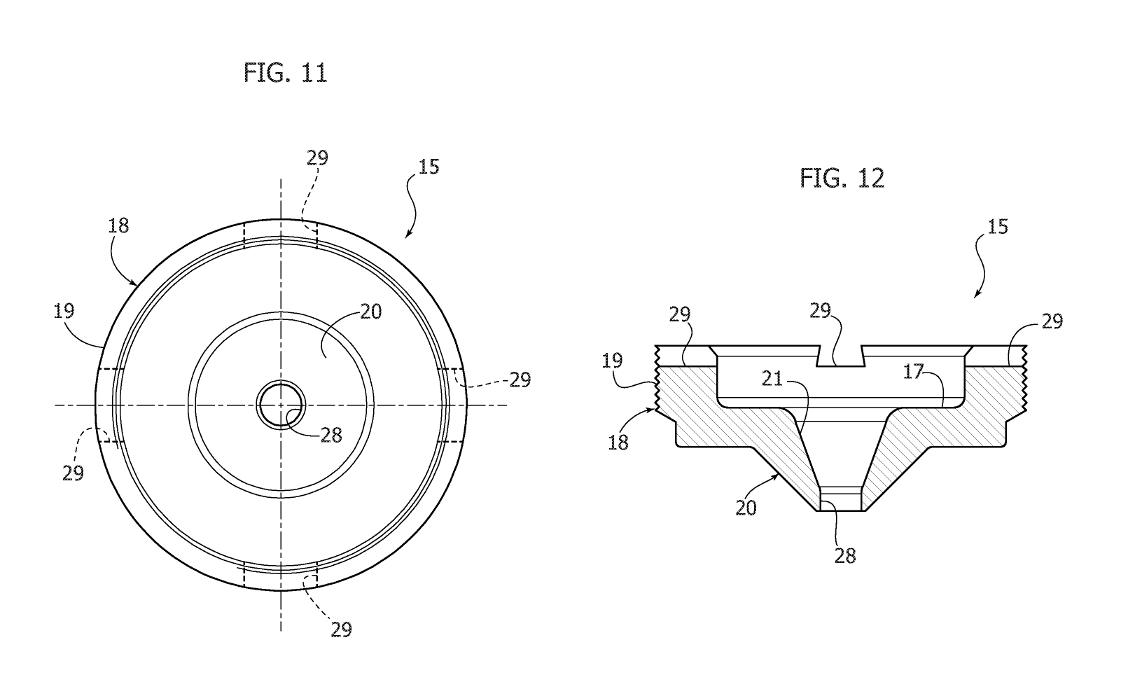

In detail, and as represented in FIGS. 10 to 12, the gate insert 15 consists of a metal hollow body having a circular base 17 with an axial perimeter wall 18 formed with an outer threading 19 and provided—at the edge thereof—with notches 29 for engaging a manoeuvring tool (not illustrated). Axially departing from the base 17 is an annular central appendage 20 projecting on the opposite side of the wall 18 and delimiting, at the free end thereof, the gate 5.

As better observable in FIG. 8, the central appendage 20 is generally conical shaped, with an inner wall 21 and an outer wall 22 having respective conical surfaces with different conicity, in a manner such that the central appendage 20 is tapered towards the mould cavity. The conicity of the outer wall 22 is complementary to that of the conical seat 16 of the die insert 14.

In a first preferred embodiment, regarding the “shutter-type” injection and visible in FIGS. 7-12, the gate insert 15 cooperates with the shutter terminal 10 of the valve pin 9 to open or close the gate 5. In particular, the distal end of the inner conical surface 21 has a cylindrical terminal portion 28, which actually forms the gate 5, whose radial thickness is considerably smaller than the transversal dimension of the cylindrical shutter terminal 10 of the valve pin 9 which—with such cylindrical portion 28—sealingly cooperates in the advanced position for closing the valve pin 9 in which the gate 5 is closed.

Thus, the cylindrical terminal portion 28 of the gate insert 15, which can also be substantially of the sharp edge type, has an aesthetically irrelevant overall thickness (e.g. about 0.2 mm) if compared with the diameter of the shutter terminal 10 (e.g. about 2.0 mm).

The outer threading 19 of the wall 18 of the gate insert 15 is engaged with a corresponding inner threading 24 formed in the wall of a recess 25 of the die insert 14. In the fully screwed condition, obtained by means of the previously mentioned manoeuvring tool, the outer conical surface 22 of the central appendage 20 rests on the conical seat 16 of the die insert 14 so that the base wall 17 of the gate insert 15 is kept spaced from the recess bottom 25 thus creating an axial gap 26.

According to a preferred configuration, the gate insert 15 has an inner geometry that is complementary to that of the shutter terminal 10 of the valve pin 9 not just at the gate, but also upstream with respect thereto. To this end, at a short distance from the shutter terminal 10, the valve pin 9 conveniently has a portion with conical surface 23 which, in proximity of the advanced closing position, rests against a part of the inner conical surface 21 of the central appendage 20 of the gate insert 15. The coupling between the conical and cylindrical surfaces of the valve pin 9 and of the central appendage 20 of the gate insert 15 attains an accurate self-centring of the shutter terminal 10 with respect to the gate 5 when closing the valve pin 9, thus ensuring a neat and clean closing of the gate 5, typical of cylindrical shutter systems. As a matter of fact, with respect to conical shutter systems, the plastic residue between the shutter terminal 10 and the wall of the gate 5, which entails inaccurate closure and ensuing defects on the moulded piece, does not occur any more.

According to an advantageous characteristic, the gate insert 15 is made of a material that is harder and more resistant to wear with respect to the die insert 14 (or to the mould plate 4), it being the only element directly cooperating with the valve pin 9. Hence, the die insert 14 may be made of less costly material, with clear advantages for the customer.

According to a further solution, when the injection apparatus is operating, the displacement speed of the valve pin 9 from the opening position to the closing position thereof, controlled electronically for example, can be conveniently reduced in the final stage of the closing movement. Thus, the centring can be carried out in an even more controlled manner, thus limiting the wear of the components and any risks of breaking the valve pin 9 besides the gate 5. Thus, this solution enables using less expensive materials for the gate insert 15, and in cascade fashion for the die insert 14 (where present).

However, should wear problems arise during the operation of the moulding apparatus, it would still be sufficient to replace the gate insert 15 (to be carried out by the supplier of the hot runner injection system) only and thus not the entire die insert 14, usually provided by the customer with high costs and production times considering the required machining operations. Thus, this would substantially not affect the customer, save for commissioning times.

Another advantage arising from the cone-cone contact between the valve pin 9 and gate insert 15 consists of the possibility of dissipating the heat of the shutter towards the die insert 14, typically provided with paths 27 for the coolant fluid. Being surrounded—during operation—by plastic material at a high temperature, the valve pin 9 tends to be particularly hot even at the gate 5 level. This entails that the plastic material actually sticks to the shutter terminal 10 of the valve pin 9. Once through with closing, the moulded piece clearly cannot be detached from the shutter terminal 10, with ensuing aesthetically unacceptable defects. The indirect contact (through the gate insert 15) between the valve pin 9 and the cooled die insert 14, enables to dissipate the heat of the valve pin 9 and thus overcome the problems related to sticking.

Besides between the valve pin 9 and the gate 5, the gate insert 15 is also designated for carrying out the centring between the injector 2, as a whole, and the gate 5. In particular, the ring nut 13 guarantees this centring by resting against the axial wall 18 of the gate insert 15, suitably machined with tolerance.

Thus, all the elements (ring nut 13, injector 2, valve pin 9, gate insert 5) are mutually centred using the same component, i.e. the gate 15. Thus, all the user of the injection apparatus needs to do is provide the conical seat 16 of the die insert 14 with due tolerances, besides just threading 24, to guarantee the centring of the gate insert 15 (and thus all elements) with respect to the gate 5.

With respect to the state of the art, and in particular in case of an outer ring nut 13, the machining of the die insert 14 by the customer is considerably simpler, quicker and less expensive, given that all that is required is to provide the conical seat 22 with the due tolerances and just threading 24.

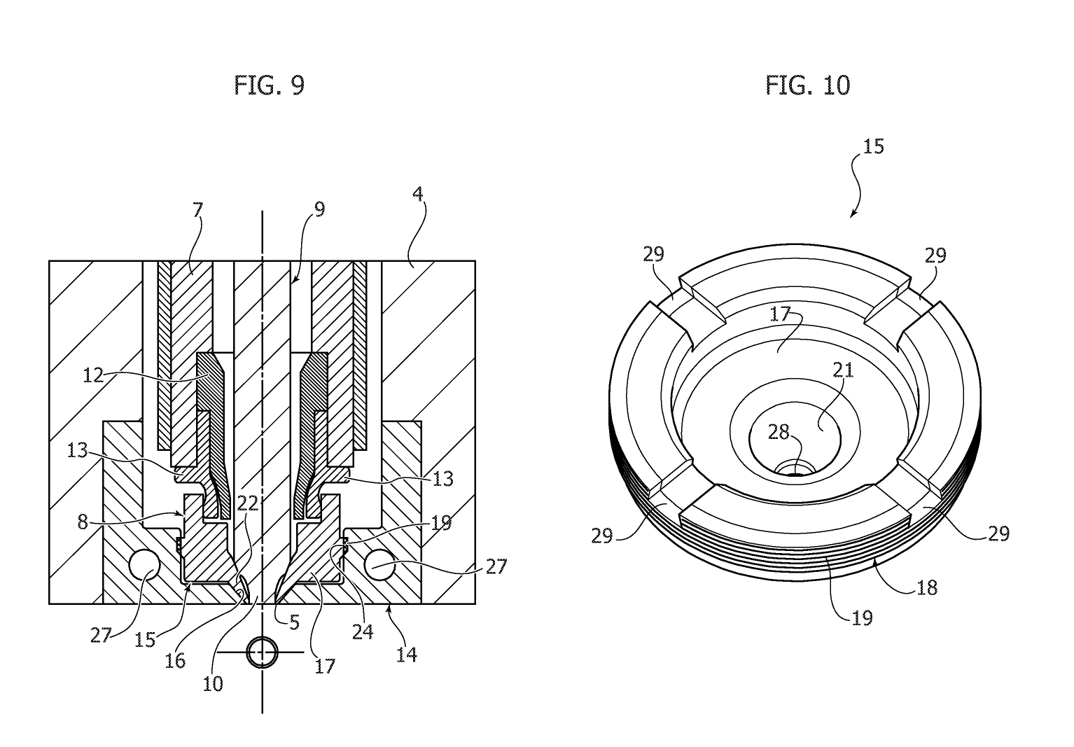

According to a further advantageous characteristic, the seat 25 obtained in the die insert 14 is configured for housing different gate inserts 15 in terms of axial extension, maintaining the conical seat 16 and the threading 24 unaltered. FIG. 9 shows an example of a different configuration in which the base 17 of the gate insert 15 has a greater thickness and the wall 18 projects further from the recess 25 towards the injector 3.

Thus, the same die insert 14 may be combined with longer or shorter injectors by simply installing a gate insert 15 with lesser or greater axial extension, without having to replace or machine the die insert 14 again.

Furthermore, it should be observed that given that there is no contact between the base 17 of the gate insert 15 and the recess 25 of the die insert 14, the presence of the aforementioned axial gap 26 enables eliminating the chances of error when performing the cone-cone centring between the gate insert 15 and the die insert 14.

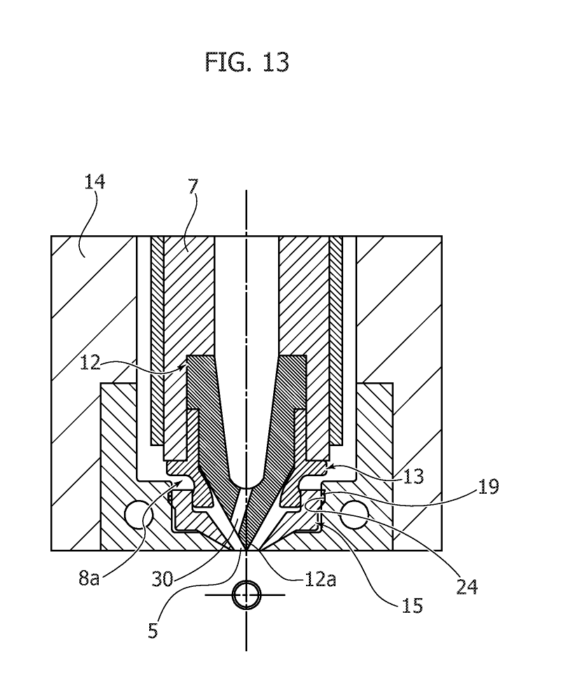

According to an alternative embodiment, shown in FIG. 13, the gate insert 15 cooperates with a nozzle terminal 8a referred to as of the “free-flow type”, i.e. without the valve pin 9 and the relative shutter terminal 10.

Similarly, to what has been described in the case of FIG. 5, the tip 12 is of the “torpedo” type, i.e. characterised by a conical-shaped distal section which ends with the vertex 12a thereof in proximity of the gate 5. The communication between the flow channel of the nozzle 7 and the gate 5 occurs through one or more inclined holes 30 obtained in the tip 12. The ring nut 13 is external, i.e. it does not project into moulding cavity directly.

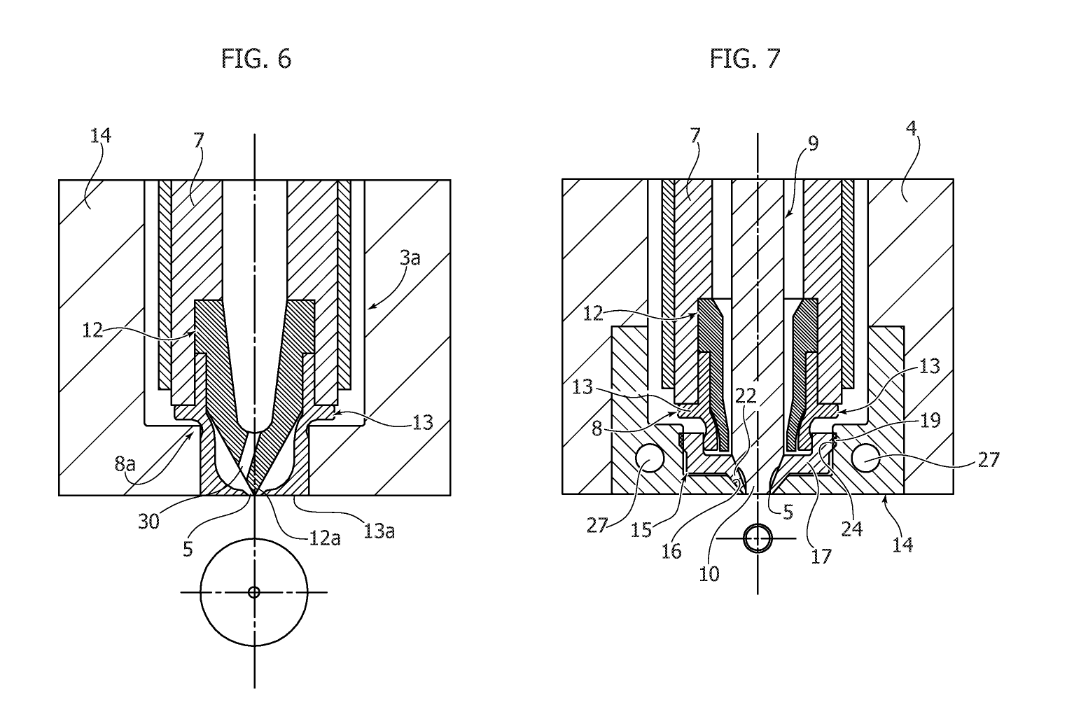

With the aim of overcoming problems arising from the accurate machining of the die insert 14, the wear as a function of the same and any unacceptability of the gate mark (in case of the “through” ring nut 13 of FIG. 6), there is provided for the use of the gate insert 15 in a manner similar to the cases described above.

The insert 15 delimits the gate 5 but leaves a small and thus aesthetically acceptable mark, as shown in plan view in the lower part of page 13. The machining required for the die insert 14 is limited to the conical seat 22 and the threading 24.

Furthermore, only the gate insert 15 is subjected to direct wear during operation due to the flow of plastic material (possibly loaded, e.g. with glass fibre) in proximity of the gate 5. Thus, according to an advantageous embodiment, the insert 15 may be made of material that is highly hard and resistant to wear. The die insert 14 may in turn conveniently be made of material that is less hard and resistant to wear, thus entailing considerable saving on costs for the customer. However, in case of excessive wear of the gate insert 15, replacement thereof will suffice, without affecting the die insert 14 in any manner whatsoever.

Lastly, all other advantages, solutions and characteristics described above regarding the preferred embodiment shall apply to the “free-flow” embodiment, obviously except for those regarding the presence of the valve pin 9 and the relative shutter terminal 10.

Obviously, without prejudice to the principle of the invention, the construction details and the embodiments may widely vary with respect to what has been described and illustrated, without departing from the scope of protection of the present invention as defined in the claims that follow. Thus, as pointed out, the presence of the die insert 14 is not strictly necessary, and the gate insert 15 will—in this case—be directly applied in a suitable seat of the mould plate or die 4, configured similarly to the recess 25.

1. An apparatus for injection moulding of plastic material, comprising:
a mould having at least one gate towards a moulding cavity and at least one injector cooperating with said at least one gate and including a nozzle provided with a nozzle terminal defining a flow path for the plastic material towards said at least one gate,
wherein the at least one gate is formed in a gate insert resting upon a centering seat of the mould having a conical surface, and
wherein said gate insert has a threading that is screwed with a corresponding inner threading of the mould.

2. The apparatus according to claim 1, wherein the gate insert has a base formed centrally with an annular axial appendage coupled with said centering seat and having a conical wall with thickness tapered towards the moulding cavity.

3. The apparatus according to claim 2, wherein said axial appendage holds said base of the gate insert axially spaced apart from a surface of the mould.

4. The apparatus according to claim 2, wherein said at least one injector is of a type comprising a valve pin having a shutter terminal and axially displaceable between a receded opening position and an advanced closing position of the at least one gate formed in said gate insert.

5. The apparatus according to claim 4, wherein said axial appendage has a cylindrical distal end portion cooperating with the shutter terminal of the valve pin in said advanced position for closing the valve pin and having a considerably smaller thickness with respect to a cross section of said shutter terminal.

6. The apparatus according to claim 5, wherein said cylindrical distal end portion has a substantially sharp edge.

7. The apparatus according to claim 4, wherein said shutter terminal of the valve pin has an axial portion with a conical surface cooperating in proximity of said advanced closing position with said conical wall of the annular axial appendage of the gate insert.

8. The apparatus according to claim 1, wherein said at least one injector is of a free-flow type.

9. The apparatus according to claim 1, wherein the gate insert is formed with a cylindrical axial wall for centering said nozzle terminal with respect to the at least one gate.

10. The apparatus according to claim 9, wherein said nozzle terminal comprises an inner tubular element or tip and an outer ring nut arranged externally to the tip, and wherein that said outer ring nut is engaged with said cylindrical axial wall.

11. The apparatus according to claim 1, wherein said gate insert is provided in different interchangeable configurations differing from one another by a greater or smaller axial extension.

12. The apparatus according to claim 1, wherein said gate insert is formed with notches designed to be engaged by a maneuvering tool for the screwing/unscrewing thereof.

13. The apparatus according to claim 1, wherein the mould comprises a mould plate or die, and wherein the mould pate or die comprises a hollow die insert applied within said mould plate and formed with said inner threading and said centering seat for said gate insert.

14. The apparatus according to claim 13, wherein said gate insert is made of a material whose hardness and wear resistance is higher than a material of said die insert.

15. The apparatus according to claim 1, wherein the mould comprises a mould plate or die, and wherein said inner threading and said centering seat for said gate insert are directly formed in said mould plate.

16. An injection moulding process by an apparatus according to claim 4, wherein a speed of displacement of the valve pin between said opening and closing positions is controlled, and wherein the speed of the valve pin during a closing movement is reduced in a final stage of such closing movement.
